(19) United States
(12) Patent Application Publication
(10) Pub. No.: US 2014/0302812 A1
(43) Pub. Date: Oct. 9, 2014

(54) ACCESS METHOD, MOBILITY MANAGEMENT DEVICE, AND USER EQUIPMENT

(71) Applicant: Huawei Technologies Co., Ltd., Shenzhen (CN)

(72) Inventor: Yijun YU, Shanghai (CN)

(21) Appl. No.: 14/308,254

(22) Filed: Jun. 18, 2014

Related U.S. Application Data
(63) Continuation of application No. PCT/CN2011/084437, filed on Dec. 22, 2011.

(51) Int. Cl. H04M 15/00; H04W 8/04

(52) U.S. Cl. CPC H04M 15/844; H04M 15/66; H04W 8/04
USPC 455/406

(57) ABSTRACT

The present invention provides an access method, a mobility management device, and a user equipment. According to the present invention, a mobility management device receives a first access request message sent by a UE, where the first access request message includes first indication information, and the first indication information is used for indicating that the UE performs equipment access processing, so that the mobility management device can perform equipment access for the UE according to the first indication information. This avoids a problem in the prior art that a UE needs to establish a subscription relationship with an operator in order to access the Internet through a mobile communications network, thereby improving access flexibility of the UE.

### CROSS-REFERENCE TO RELATED APPLICATIONS

This application is a continuation of International Patent Application No. PCT/CN2011/084437, filed on Dec. 22, 2011, which is hereby incorporated by reference in its entirety.

### TECHNICAL FIELD

The present invention relates to a communications technology, and in particular, to an access method, a mobility management device, and a user equipment.

### BACKGROUND

Generally, a user equipment (User Equipment, UE for short) may access the Internet through a mobile communications network to which the user equipment belongs, to implement a data service provided by the Internet, such as QQ, Sina Weibo, webpage browsing, or email.

However, in the prior art, in order to access the Internet through the mobile communications network, the UE needs to establish a subscription relationship with an operator, for example, establish a subscription relationship with an operator by using a subscriber card inserted into the UE, which leads to a decrease in access flexibility of the UE.

### SUMMARY

The present invention provides an access method, a mobility management device, and a user equipment, so as to improve access flexibility of a UE.

According to one aspect, an access method is provided, and includes:

receiving, by a mobility management device, a first access request message sent by a UE, where the first access request message includes first indication information, and the first indication information is used for indicating that the UE performs equipment access processing; and

performing, by the mobility management device, equipment access for the UE according to the first indication information.

According to another aspect, a mobility management device is provided, and includes:

a receiving unit, configured to receive a first access request message sent by a UE, where the first access request message includes first indication information, and the first indication information is used for indicating that the UE performs equipment access processing; and

an access unit, configured to perform equipment access for the UE according to the first indication information.

According to another aspect, a user equipment is provided, and includes:

a sending unit, configured to send a first access request message to a mobility management device, where the first access request message includes first indication information, and the first indication information is used for indicating that the UE performs equipment access processing, so that the mobility management device performs equipment access for the UE according to the first indication information.

It can be known from the foregoing technical solutions that, in the embodiments of the present invention, a mobility management device receives a first access request message sent by a UE, where the first access request message includes first indication information, and the first indication information is used for indicating that the UE performs equipment access processing, so that the mobility management device can perform equipment access for the UE according to the first indication information. This avoids a problem in the prior art that a UE needs to establish a subscription relationship with an operator in order to access the Internet through a mobile communications network, thereby improving access flexibility of the UE.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of an access method according to an embodiment of the present invention;

FIG. 2 is a schematic flowchart of an access method according to another embodiment of the present invention;

FIG. 3 is a schematic flowchart of an access method according to another embodiment of the present invention;

FIG. 4 is a schematic flowchart of an access method according to another embodiment of the present invention;

FIG. 5 is a schematic flowchart of an access method according to another embodiment of the present invention;

FIG. 6 is a schematic structural diagram of a mobility management device according to another embodiment of the present invention;

FIG. 7 is a schematic structural diagram of a mobility management device according to another embodiment of the present invention;

FIG. 8 is a schematic structural diagram of a user equipment according to another embodiment of the present invention; and

FIG. 9 is a schematic structural diagram of a user equipment according to another embodiment of the present invention.

### DESCRIPTION OF EMBODIMENTS

To make the objectives, technical solutions, and advantages of the embodiments of the present invention more clearly, the following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

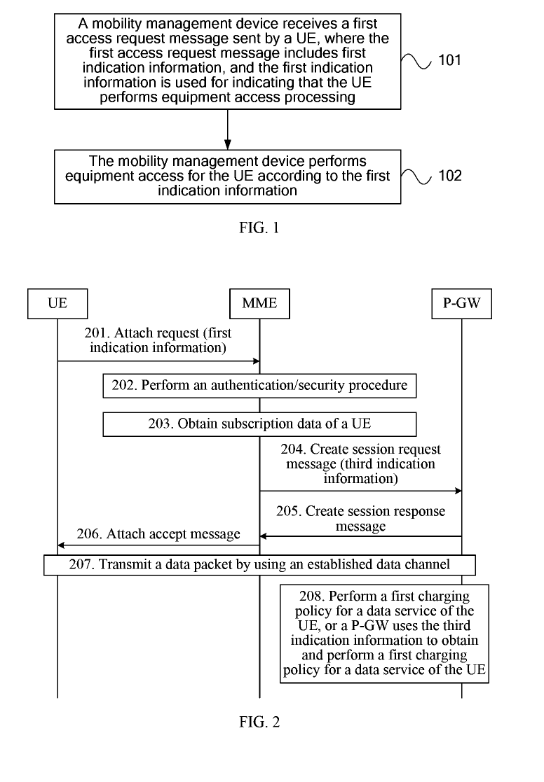

FIG. 1 is a schematic flowchart of an access method according to an embodiment of the present invention. As shown in FIG. 1, the access method in this embodiment may include:

101: A mobility management device receives a first access request message sent by a UE, where the first access request message includes first indication information, and the first indication information is used for indicating that the UE performs equipment access processing.

102: The mobility management device performs equipment access for the UE according to the first indication information.

The equipment access refers to a mechanism that, in a case where there is no valid subscription data, the UE still can register in a mobile communications network. As for the equipment access mechanism, a specific charging manner is generally used, for example, after completing the equipment access, the UE needs to input information, such as an account number, before accessing a data service so as to perform charging.

A typical scenario of the equipment access is that, the UE does not have a subscriber identity module (Subscriber Identity Module, SIM for short) card or a universal integrated circuit card (Universal Integrated Circuit Card, UICC for short); in this case, the UE identifies the UE by using an international mobile equipment identity (International Mobile Equipment Identity, IMEI for short) of the UE instead of an identifier recorded in the SIM card or the UICC (such as an IMSI, or a P-TMSI or a GUTI), and adds the IMEI in a registration request message (such as an attach message) sent to a mobile communications network; and a device (such as a mobility management device) in the mobile communications network accepts the registration request according to the first indication information.

When the UE has the valid subscription data, and the UE also allows to perform the foregoing equipment access request, the UE may use the identifier (such as the P-TMSI or the GUTI) recorded in the SIM card or the UICC to identify the UE; and the device (such as a mobility management device) in the mobile communications network accepts the registration request according to the first indication information.

When the UE has the valid subscription data, and completes normal access (that is, not the equipment access), the UE may still instruct, by using a location update procedure, the mobile communications network to modify a normal access manner to an equipment access manner. In addition, after completing the foregoing normal access, the UE may also indicate, to the mobile communications network in a bearer establishment procedure, such as a PDN connectivity establishment procedure or PDP activation, that the PDN connectivity or the PDP uses the equipment access manner.

After the UE completes the equipment access, the UE may obtain at least one valid IP address from the mobile communications network, and the UE may use the IP address to implement a subsequent data service. Generally, before the UE implements the data service, the UE is generally required to perform further identity authentication, so as to meet a demand, such as charging.

Accordingly, a capability of the UE for supporting the equipment access refers to that the UE can provide the foregoing mechanism. A capability of the mobile communications network for supporting the equipment access refers to that the device in the mobile communications network can provide the foregoing mechanism, including that a mobility management entity in the mobile communications network accepts the registration request that the UE is identified by using the IMEI, the mobile communications network can provide at least one valid IP address to the UE performing the equipment access, and the like.

Optionally, before 101, the mobility management device or a wireless access device may further send second indication information to the UE, where the second indication information is used for indicating that the mobile communications network, to which the mobility management device or the wireless access device belongs, supports the UE to perform the equipment access processing. For example, the wireless access device may send a broadcast message, where the broadcast message includes the second indication information, and after receiving the foregoing broadcast message, the UE may know that the mobile communications network, to which the wireless access device belongs, supports an equipment access function. For another example, the mobility management device receives a second access request message sent by the UE, and may send a second access response message to the UE, where the second access response message includes the second indication information; and after receiving the foregoing second access response message, the UE may immediately know that the mobile communications network, to which the mobility management device belongs, supports the equipment access function. The second access request message may include, but is not limited to, an attach request message, a location update request message, a packet data network (Packet Data Network, PDN for short) connectivity request message, or an activate packet data protocol (Packet Data Protocol, PDP for short) context request message; accordingly, the second access response message may correspondingly include an attach accept message, an attach reject message, a location update accept message, a location update reject message, a PDN connectivity accept message, a PDN connectivity reject message, an activate PDP context accept message, or an activate PDP context reject message.

Optionally, the first access request message may include, but is not limited to, the attach request message, the location update request message, the PDN connectivity request message, or the activate PDP context request message.

In an optional embodiment of the present invention, if the first access request message is the attach request message, in 102, the mobility management device may specifically construct a context of the UE, where the context of the UE is generated by the mobility management device according to the subscription data of the UE provided by an HLR/HSS; if the mobility management device cannot acquire the valid subscription data of the UE from the HLR/HSS, for example, the HLR/HSS has no subscription data of the UE, or the UE is not allowed to perform access at a current location, the mobility management device may generate the context of the UE according to the first indication information and according to local configuration data or default data, and the mobility management device accepts the first access request message according to the first indication information.

In an application scenario of the embodiment of the present invention, after the mobility management device accepts the first access request message, the mobility management device may further send a first create session request message to a gateway device according to the first indication information, where the first create session request message includes third indication information, and the third indication information is used for instructing the gateway device to perform a first charging policy for a data service of the UE, or instructing the gateway device to use the third indication information to obtain and perform a first charging policy for the data service of the UE.

In another application scenario of the embodiment of the present invention, after the mobility management device accepts the first access request message, the mobility management device may further receive the activate PDP context request message sent by the UE, and send a second create session request message to the gateway device according to the first indication information, where the second create session request message includes fourth indication information, and the fourth indication information is used for instructing the gateway device to perform the first charging policy for the data service of the UE, or instructing the gateway device to use the fourth indication information to obtain and perform the first charging policy for the data service of the UE.

In an optional embodiment of the present invention, if the first access request message is the PDN connectivity request message or the activate PDP context request message, in 102, the mobility management device may specifically send a third create session request message to the gateway device according to the first indication information, where the third create session request message includes fifth indication information, and the fifth indication information is used for instructing the gateway device to perform the first charging policy for the data service of the UE, or instructing the gateway device to use the fifth indication information to obtain and perform the first charging policy for the data service of the UE.

In an optional embodiment of the present invention, if the first access request message is the location update request message, in 102, the mobility management device may specifically send a delete bearer request message to the gateway device according to the first indication information, receive a delete bearer response message sent by the gateway device, and send a fourth create session request message to the gateway device, where the fourth create session request message includes sixth indication information, and the sixth indication information is used for instructing the gateway device to perform the first charging policy for the data service of the UE, or instructing the gateway device to use the sixth indication information to obtain and perform the first charging policy for the data service of the UE.

In an optional embodiment of the present invention, if the first access request message is the location update request message, in 102, the mobility management device may further specifically send a modify bearer request message to the gateway device according to the first indication information, where the modify bearer request message includes seventh indication information, and the seventh indication information is used for instructing the gateway device to perform the first charging policy for the data service of the UE, or instructing the gateway device to use the seventh indication information to obtain and perform the first charging policy for the data service of the UE.

Optionally, after 102, the mobility management device may further receive a third access request message sent by the UE, where the third access request message includes eighth indication information, the eighth indication information is used for indicating that the UE cancels the equipment access, and the mobility management device cancels the equipment access for the UE according to the eighth indication information.

Optionally, the third access request message may include, but is not limited to, the location update request message, the PDN connectivity request message, or the activate PDP context request message.

In an optional embodiment of the present invention, if the third access request message is the PDN connectivity request message or the activate PDP context request message, the mobility management device may specifically send a sixth create session request message to the gateway device according to the eighth indication information, where the sixth create session request message includes tenth indication information, and the tenth indication information is used for instructing the gateway device to perform a second charging policy for the data service of the UE, or instructing the gateway device to use the tenth indication information to obtain and perform a second charging policy for the data service of the UE.

In an optional embodiment of the present invention, if the third access request message is the location update request message, if the context of the UE stored in the mobility management device is generated according to the local configuration data or the default data, or if the mobility management device cannot acquire the subscription data of the UE from the HLR/HSS, or if the subscription data of the UE acquired by the mobility management device from the HLR/HSS does not allow access of the UE, the mobility management device may specifically perform a detach (Detach) procedure according to the eighth indication information.

In an optional embodiment of the present invention, if the third access request message is the location update request message, the mobility management device may specifically send the delete bearer request message to the gateway device according to the eighth indication information, and receive the delete bearer response message sent by the gateway device, and the mobility management device sends the sixth create session request message to the gateway device, where the sixth create session request message includes eleventh indication information, and the eleventh indication information is used for instructing the gateway device to perform the second charging policy for the data service of the UE, or instructing the gateway device to use the eleventh indication information to obtain and perform the second charging policy for the data service of the UE.

In an optional embodiment of the present invention, if the third access request message is the location update request message, the mobility management device may further specifically send the modify bearer request message to the gateway device, where the modify bearer request message includes twelfth indication information, and the twelfth indication information is used for instructing the gateway device to perform the second charging policy for the data service of the UE, or instructing the gateway device to use the twelve indication information to obtain and perform the second charging policy for the data service of the UE.

In this embodiment, a mobility management device receives a first access request message sent by a UE, where a first access request message includes first indication information, and the first indication information is used for indicating that the UE performs equipment access processing, so that the mobility management device can perform equipment access for the UE according to the first indication information. This avoid a problem in the prior art that a UE needs to establish a subscription relationship with an operator in order to access the Internet through a mobile communications network, thereby improving access flexibility of the UE.

The technical solutions of the present invention may be applied in various communications systems, such as a General Packet Radio Service (General Packet Radio Service, GPRS for short) system, a Wideband Code Division Multiple Access (Wideband Code Division Multiple Access, WCDMA for short) system, and a long term evolution (Long Term Evolution, LTE for short) system.

The mobility management device may be a serving General Packet Radio Service (General Packet Radio Service, GPRS for short) supporting node (Serving GPRS Supporting Node, SGSN for short) in the GPRS/WCDMA system, and may further be a mobility management entity (Mobility Management Entity, MME for short) in the LTE system.

The wireless access device may be a base station (Base Transceiver Station, BTS for short) in the GPRS system, may further be a base station (NodeB) in the WCDMA system, and may further be an evolved base station (Evolved NodeB, eNodeB or eNB for short) in the LTE system, or the like.

The gateway device may be a gateway GPRS supporting node (Gateway GPRS Supporting Node, GGSN for short) in the GPRS/WCDMA system, and may further be a packet data network gateway (Packet Data Network Gateway, P-GW for short) in the LTE system.

To make the method provided in the embodiment of the present invention more clearly, the LTE system is used as an example in the following. A procedure of accessing the GPRS/WCDMA is processed similarly, and a difference thereof is mainly a difference of a name of a network device: in a case where the GPRS/WCDMA is accessed, the MME is replaced by the SGSN in the following embodiment, and when the SGSN is a Gn/Gp SGSN, the P-GW is replaced by the GGSN, and the SGSN directly communicates with the GGSN, that is, the S-GW does not exist; and when the SGSN is an S4 SGSN, the SGSN communicates with the P-GW by using the S-GW. The so-called Gn/Gp SGSN refers to that the SGSN communicates with the GGSN through a Gn/Gp interface; and the so-called S4 SGSN refers to that the SGSN communicates with the S-GW through an S4 interface, and then communicates with the P-GW.

FIG. 2 is a schematic flowchart of an access method according to another embodiment of the present invention. As shown in FIG. 2, the access method in this embodiment may include:

201: A UE sends an attach request (Attach Request) message to an MME, where the attach request message includes first indication information, and the first indication information is used for indicating that the UE performs equipment access processing.

202: The MME performs an authentication/security procedure.

If in 201, the attach request message received by the MME includes a global unique temporary identity (Global Unique Temporary Identity, GUTI for short) or an international mobile subscriber identity (International Mobile Subscriber Identity, IMSI for short) of the UE, the MME interacts with a home location register (Home Location Register, HLR for short)/home subscriber server (Home Subscriber Server, HSS for short), performs the authentication/security procedure, and acquires an authentication/security parameter of the UE.

If in 201, the attach request message received by the MME does not include the GUTI or the IMSI of the UE, but includes the IMEI of the UE, the MME does not interact with the HLR/HSS according to the first indication information included in the attach request message in step 201, and generates the authentication/security parameter of the UE according to local configuration data or default data.

203: The MME obtains subscription data of the UE.

If in 201, the attach request message received by the MME includes the GUTI or the IMSI of the UE, the MME interacts with the HLR/HSS, performs an update location procedure, obtains the subscription data of the UE, and generates a context of the UE. If the MME cannot acquire valid subscription data from the HLR/HSS, for example, the UE has no subscription data, or the UE is not allowed to perform access at a current location, or when in step 201, the IMEI of the UE is included in the attach request message received by the MME, the MME generates the context of the UE according to the first indication information included in the attach request message in step 201 and according to the local configuration data or the default data.

204: The MME sends a create session request (Create Session Request) message to a P-GW by using a serving gateway (Serving Gateway, S-GW for short) according to the first indication information included in the attach request message, where the create session request message includes third indication information, and the third indication information is used for instructing the P-GW to perform a first charging policy for a data service of the UE, or instructing the P-GW to use the third indication information to obtain and perform a first charging policy for a data service of the UE.

For example, the third indication information may be a specific access point name (Access Point Name, APN for short), or may also be an independent indication identifier, which is not limited in this embodiment.

Optionally, before 204, the MME may further receive an activate PDP context request message sent by the UE, and then, perform 204.

205: The P-GW sends a create session response (Create Session Response) message to the MME by using the S-GW.

Optionally, the foregoing create session response message may further include indication information, so as to indicate that the P-GW performs the equipment access processing for the UE, that is, the P-GW performs the first charging policy for the data service of the UE, or uses the indication information to obtain and perform the first charging policy for the data service of the UE.

206: The MME sends an attach accept (Attach Accept) message to the UE.

Optionally, the foregoing attach accept message may further include the indication information, so as to indicate that a network side performs the equipment access processing for the UE, that is, the P-GW performs the first charging policy for the data service of the UE, or uses the indication information to obtain and perform the first charging policy for the data service of the UE.

So far, the network side completes establishing a data channel for the data service of the UE.

207: The UE transmits a data packet through the established data channel

208: After the P-GW receives the data packet, the P-GW performs the first charging policy for the data service of the UE, or the P-GW uses the third indication information to obtain and perform the first charging policy for the data service of the UE.

For example, the first charging policy may specifically be that: the P-GW sends a triggering message to a portal server (Portal Server), so as to trigger to complete charging processing. Accordingly, the portal server sends a webpage for data service charging to the UE according to the received triggering message, and the foregoing webpage may prompt a user of the UE to input a credit card account number to purchase a charging quota, such as charged traffic or a charged duration; and may also prompt the user of the UE to input information of an existing charging account and the like.

So far, the user of the UE may make a payment based on the charging quota according to the webpage for the data service charging provided by the portal server, so as to complete charging of the data service.

It should be noted that: if the UE accesses the GPRS system or the WCDMA system, step 204 to step 205, and step 207 to step 208 in the foregoing attach procedure are not performed.

In this embodiment, in an attach procedure of a UE, an MME receives an attach request message sent by the UE, where the attach request message includes first indication information, and the first indication information is used for indicating that the UE performs equipment access processing, so that the MME can perform equipment access for the UE according to the first indication information. This avoid a problem in the prior art that a UE needs to establish a subscription relationship with an operator in order to access the Internet through a mobile communications network, thereby improving access flexibility of the UE.

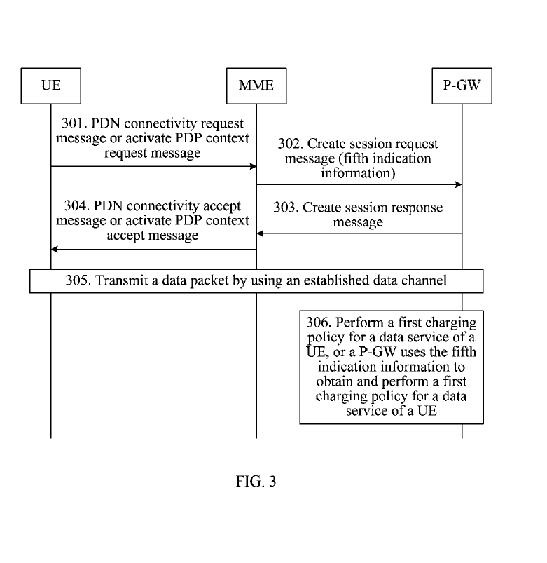

FIG. 3 is a schematic flowchart of an access method according to another embodiment of the present invention. As shown in FIG. 3, the access method in this embodiment may include:

301: A UE sends a PDN connectivity request (PDN Connectivity Request) message or an activate PDP context request (Activate PDP Context Request) message to an MME, where the PDN connectivity request message includes first indication information, and the first indication information is used for indicating that the UE performs equipment access processing.

If the MME does not support specific processing (that is, the UE performs the equipment access processing) indicated by the foregoing first indication information, the MME sends a PDN connectivity reject (PDN Connectivity Reject) message or an activate PDP context reject (Activate PDP Context Reject) message to the UE, and the procedure is terminated.

302: The MME sends a create session request message to a P-GW by using an S-GW according to the first indication information included in the PDN connectivity request message or the activate PDP context request message, where the create session request message includes fifth indication information, and the fifth indication information is used for instructing the P-GW to perform a first charging policy for a data service of the UE, or instructing the P-GW to use the fifth indication information to obtain and perform a first charging policy for a data service of the UE.

For example, the fifth indication information may be a specific APN, or may also be an independent indication identifier, which is not limited in this embodiment.

The foregoing create session request message may specifically be a create PDP context request (Create PDP Context Request) message in a GPRS system or a WCDMA system or a create session request (Create Session Request) message in an LTE system.

303: The P-GW sends a create session response (Create Session Response) message to the MME by using the S-GW.

Optionally, the foregoing create session response message may further include indication information, so as to indicate that the P-GW performs the equipment access processing for the UE, that is, the P-GW performs the first charging policy for the data service of the UE, or uses the indication information to obtain and perform the first charging policy for the data service of the UE.

304: The MME sends a PDN connectivity accept (PDN Connectivity Accept) message or an activate PDP context accept (Activate PDP Context Accept) message to the UE.

Optionally, the foregoing PDN connectivity accept message or activate PDP context accept message may further include the indication information, so as to indicate that a network side performs the equipment access processing for the UE, that is, the P-GW performs the first charging policy for the data service of the UE, or uses the indication information to obtain and perform the first charging policy for the data service of the UE.

So far, the network side completes establishing a data channel for the data service of the UE.

305: The UE transmits a data packet through the established data channel

306: After the P-GW receives the data packet, the P-GW performs the first charging policy for the data service of the UE, or the P-GW uses the fifth indication information to obtain and perform the first charging policy for the data service of the UE.

For example, the first charging policy may specifically be that: the P-GW sends a triggering message to a portal server (Portal Server), so as to trigger to complete charging processing. Accordingly, the portal server sends a webpage for data service charging to the UE according to the received triggering message, and the foregoing webpage may prompt a user of the UE to input a credit card account number to purchase a charging quota, such as charged traffic or a charged duration; and may also prompt the user of the UE to input information of an existing charging account and the like.

So far, the user of the UE may make a payment based on the charging quota according to the webpage for the data service charging provided by the portal server, so as to complete charging of the data service.

In this embodiment, in a procedure of establishing a new data channel by a UE, an MME receives a PDN connectivity request message or an activate PDP context request message sent by the UE, where the PDN connectivity request message or the activate PDP context request message includes first indication information, and the first indication information is used for indicating that the UE performs equipment access processing, so that the MME can perform equipment access for the UE according to the first indication information. This avoid a problem in the prior art that a UE needs to establish a subscription relationship with an operator in order to access the Internet through a mobile communications network, thereby improving access flexibility of the UE.

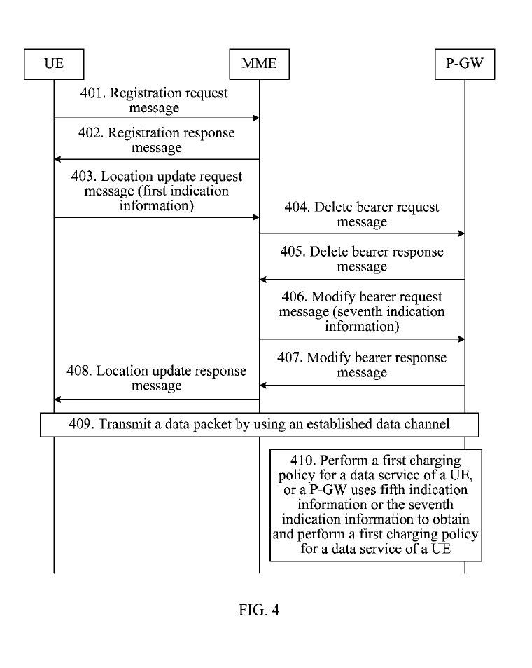

FIG. 4 is a schematic flowchart of an access method according to another embodiment of the present invention. As shown in FIG. 4, the access method in this embodiment may include:

401: A UE sends a registration request message to an MME.

The foregoing registration request message may include, but is not limited to, an attach request (Attach Request) message, or a location update request message (may include, but is not limited to, a routing area update request (RAU Request) message or a tracking area update request (TAU Request) message).

402: The MME performs a registration procedure, and returns a registration response message.

For example, the MME interacts with an HLR/HSS, acquires subscription data of the UE, and the like, and sends the registration response message to the UE.

When a network supports performing of equipment access processing by the UE, second indication information is included in the registration response message, and the second indication information is used for indicating that a network side supports the UE to perform the equipment access processing.

If the UE has no valid subscription data, or is not allowed to access the network, the MME sends the registration response message to the UE. The registration response message may include, but is not limited to, an attach reject (Attach Reject) message, or a location update accept message (which may include, but is not limited to, a routing area update reject (RAU Reject) message or a tracking area update reject (TAU Reject) message).

In this case, if the UE supports the foregoing equipment access processing, after receiving an indication sent by the MME and indicating that the network supports the UE to perform the equipment access processing, the UE may perform steps in the embodiment corresponding to FIG. 2 to reinitiate an attach procedure, and the UE provides a first indication in the attach procedure, and performs the equipment access processing.

If the UE is allowed to access the network, the MME may send the registration response message to the UE, where the registration response message may include, but is not limited to, an attach accept (Attach Accept) message, or a location update accept message (which may include, but is not limited to, a routing area update accept (RAU Accept) message or a tracking area update accept (TAU Accept) message).

In this case, if the UE supports the equipment access processing, the UE may perform steps in the embodiment corresponding to FIG. 2 to reinitiate the attach procedure, or perform the foregoing steps.

403: The UE sends the location update request message to the MME, where the location update request message includes first indication information, and the first indication information is used for indicating that the UE performs the equipment access processing.

The foregoing location update request message may include, but is not limited to, the routing area update request (RAU Request) message or the tracking area update request (TAU Request) message.

404: The MME sends a delete bearer request message to a P-GW by using an S-GW.

If a current UE has already established a bearer (such as a PDP context or an EPS bearer) using an EPS standard charging mode, the MME may send the delete bearer request message to the P-GW by using the S-PW, so as to delete the bearer that has already been established by the UE.

The foregoing delete bearer request message may include, but is not limited to, a delete PDP context request (Delete PDP Context Request) message or a delete bearer command (Delete Bearer Command) message.

405: The P-GW deletes the bearer, and sends a delete bearer response message to the MME by using the S-GW.

For example, the P-GW receives the delete PDP context request (Delete PDP Context Request) message; the P-GW deletes the bearer, and sends the delete PDP context response (Delete PDP Context Response) message to the MME by using the S-GW.

For another example, the P-GW receives the delete bearer command (Delete Bearer Command) message, the P-GW initiates a delete bearer procedure, that is, the P-GW sends the delete bearer request (Delete Bearer Request) message to the MME by using the S-GW, and then the MME sends the delete bearer response (Delete Bearer Response) message to the P-GW by using the S-GW.

Optionally, according to a service demand, after a relevant bearer is deleted, the UE or the P-GW may initiate a bearer establishment procedure again, and for the bearer establishment procedure initiated by the UE, reference may be specifically made to relevant content in the embodiment corresponding to FIG. 3, which is not described herein again. Similarly, in a bearer establishment procedure initiated by the P-GW, the MME may similarly instruct, by using indication information and in a bearer establishment response message sent to the P-GW, the P-GW to perform a first charging policy for a data service of the UE, or instruct the P-GW to use fifth indication information in the embodiment corresponding to FIG. 3 to obtain and perform a first charging policy for a data service of the UE.

Alternatively, 404 and 405 may also not be performed, and 406 and 407 are performed.

406: The MME sends a modify bearer request message to the P-GW by using the S-GW, where the modify bearer request message includes seventh indication information, and the seventh indication information is used for instructing a gateway device to perform the first charging policy for the data service of the UE, or instructing the gateway device to use the seventh indication information to obtain and perform the first charging policy for the data service of the UE.

The foregoing modify bearer request message may include, but is not limited to, an update PDP context request (Update PDP Context Request) message or a modify bearer command (Modify Bearer Command) message.

407: The P-GW modifies the bearer, and sends a modify bearer response message to the MME by using the S-GW.

For example, the P-GW receives the update PDP context request (Update PDP Context Request) message; and the P-GW updates the bearer, and sends an update PDP context response (Update PDP Context Response) message to the MME by using the S-GW.

For another example, the P-GW receives the modify bearer command (Modify Bearer Command) message, the P-GW initiates an update bearer procedure, that is, the P-GW sends an update bearer request (Update Bearer Request) message to the MME by using the S-GW, and then the MME sends an update bearer response (Update Bearer Response) message to the P-GW by using the S-GW.

408: The MME sends a location update response message to the UE.

The foregoing location update response message may include, but is not limited to, a routing area update accept (RAU Accept) message or a tracking area update accept (TAU Accept) message.

Optionally, the foregoing location update response message may further include the indication information, so as to indicate that a network side performs the equipment access processing for the UE, that is, the P-GW performs the first charging policy for the data service of the UE, or uses the seventh indication information to obtain and perform the first charging policy for the data service of the UE.

So far, the network side completes establishing a data channel for the data service of the UE.

409: The UE transmits a data packet through the established data channel

410: After the P-GW receives the data packet, the P-GW performs the first charging policy for the data service of the UE, or the P-GW uses the fifth indication information or the seventh indication information to obtain and perform the first charging policy for the data service of the UE.

For example, the first charging policy may specifically be that: the P-GW sends a triggering message to a portal server (Portal Server), so as to trigger to complete charging processing. Accordingly, the portal server sends a webpage for data service charging to the UE according to the received triggering message, and the foregoing webpage may prompt a user of the UE to input a credit card account number to purchase a charging quota, such as charged traffic or a charged duration; and may also prompt the user of the UE to input information of an existing charging account and the like.

So far, the user of the UE may make a payment based on the charging quota according to the webpage for the data service charging provided by the portal server, so as to complete charging of the data service.

In this embodiment, a UE learns in a registration procedure that a mobile communications network supports the UE to perform equipment access processing, and the UE completes, according to an indication, equipment access processing by performing an attach procedure or a location update procedure which carries first indication information. In the location update procedure of the UE, an MME receives a location update request message sent by the UE, where the location update request message includes the first indication information, and the first indication information is used for indicating that the UE performs the equipment access processing, so that the MME can perform the equipment access for the UE according to the first indication information. This avoid a problem in the prior art that a UE needs to establish a subscription relationship with an operator in order to access the Internet through a mobile communications network, thereby improving access flexibility of the UE.

It should be noted that: in this embodiment, before performing the location update procedure carrying the first indication information for the equipment access, the UE does not need to first perform the registration procedure of step 401 to step 402, that is, step 403 to step 410 may be independently performed, and an indication of whether the UE supports the equipment access processing does not depend on the mobile communications network. When the UE performs the location update procedure requesting performing of the equipment access, if the mobile communications network does not support an equipment access function, the MME rejects a location update request of the UE.

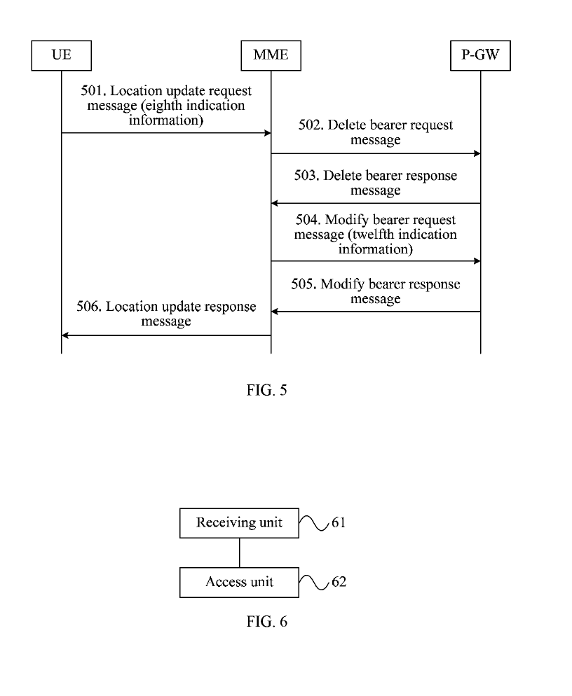

FIG. 5 is a schematic flowchart of an access method according to another embodiment of the present invention. As shown in FIG. 5, based on the embodiments corresponding to FIG. 2, FIG. 3, and FIG. 4, that is, after a user of a UE may make a payment according to a charging quota according to a webpage of data service charging provided by a portal server, to complete charging of a data service, the access method of this embodiment may further include:

501: The UE sends a location update request message to an MME, where the location update request message includes eighth indication information, and the eighth indication information is used for indicating that the UE cancels equipment access.

The foregoing location update request message may include, but is not limited to, a routing area update request (RAU Request) message or a tracking area update request (TAU Request) message.

502: The MME sends a delete bearer request message to a P-GW by using an S-GW.

If a current UE has already established a bearer (such as a PDP context or an EPS bearer) using a non-EPS standard charging mode, the MME may send the delete bearer request message to the P-GW by using the S-PW, so as to delete the bearer that has already been established by the UE.

The foregoing delete bearer request message may include, but is not limited to, a delete PDP context request (Delete PDP Context Request) message or a delete bearer command (Delete Bearer Command) message.

503: The P-GW deletes the bearer, and sends a delete bearer response message to the MME by using the S-GW.

For example, the P-GW receives the delete PDP context request (Delete PDP Context Request) message; the P-GW deletes the bearer, and sends the delete PDP context response (Delete PDP Context Response) message to the MME by using the S-GW.

For another example, the P-GW receives the delete bearer command (Delete Bearer Command) message, the P-GW initiates a delete bearer procedure, that is, the P-GW sends a delete bearer request (Delete Bearer Request) message to the MME by using the S-GW, and then the MME sends the delete bearer response (Delete Bearer Response) message to the P-GW by using the S-GW.

Optionally, according to a service demand, after a relevant bearer is deleted, the UE or the P-GW may initiate a bearer establishment procedure again, and for a bearer establishment procedure initiated by the UE or the P-GW, reference may be specifically made to relevant content in the prior art, which is not described herein again.

Alternatively, 502 and 503 may also not be performed, and 504 and 505 are performed.

504: The MME sends a modify bearer request message to the P-GW by using the S-GW, where the modify bearer request message includes twelfth indication information, and the twelfth indication information is used for instructing a gateway device to perform a second charging policy for a data service of the UE, or instructing a gateway device to use the twelfth indication information to obtain and perform a second charging policy for a data service of the UE.

The foregoing modify bearer request message may include, but is not limited to, an update PDP context request (Update PDP Context Request) message or a modify bearer command (Modify Bearer Command) message.

505: The P-GW modifies the bearer, and sends a modify bearer response message to the MME by using the S-GW.

For example, the P-GW receives the update PDP context request (Update PDP Context Request) message; and the P-GW updates the bearer, and sends an update PDP context response (Update PDP Context Response) message to the MME by using the S-GW.

For another example, the P-GW receives the modify bearer command (Modify Bearer Command) message, the P-GW initiates an update bearer procedure, that is, the P-GW sends an update bearer request (Update Bearer Request) message to the MME by using the S-GW, and then the MME sends an update bearer response (Update Bearer Response) message by using the S-GW.

506: The MME sends a location update response message to the UE.

The foregoing location update response message may include, but is not limited to, a routing area update accept (RAU Accept) message or a tracking area update accept (TAU Accept) message.

Optionally, the foregoing location update response message may further include indication information, so as to indicate that a network side performs equipment access processing for the UE, that is, the P-GW may not perform a first charging policy for the data service of the UE, or may not use other indication information to obtain and perform a first charging policy for the data service of the UE.

So far, the network side cancels the equipment access processing for the UE.

In this embodiment, in a location update procedure of a UE, an MME receives a location update request message sent by the UE, where the location update request message includes eighth indication information, and the eighth indication information is used for indicating that the UE cancels equipment access, so that the MME can cancel the equipment access for the UE according to the eighth indication information. This avoid a problem in the prior art that a UE needs to establish a subscription relationship with an operator in order to access the Internet through a mobile communications network, thereby improving access flexibility of the UE.

It should be noted that: for simple description, the foregoing method embodiments are expressed as a combination of a series of actions. However, persons skilled in the prior art should know that the present invention is not limited to the described action sequence, which is because some steps may use another sequence or be performed simultaneously according to the present invention. In addition, persons skilled in the prior art should also know that, embodiments described in the specification are exemplary embodiments, and actions and modules involved are not necessarily required in the present invention.

In the foregoing embodiment, description for each embodiment has its emphasis, and for a part of an embodiment which is not described in detail, reference may be made to relevant descriptions of other embodiments.

FIG. 6 is a schematic structural diagram of a mobility management device according to another embodiment of the present invention. As shown in FIG. 6, the mobility management device in this embodiment may include a receiving unit 61 and an access unit 62. The receiving unit 61 is configured to receive a first access request message sent by a UE, where the first access request message includes first indication information, and the first indication information is used for indicating that the UE performs equipment access processing; and the access unit 62 is configured to perform equipment access for the UE according to the first indication information.

All functions of the mobility management device in the embodiment corresponding to the foregoing FIG. 1 and the MMEs in the embodiments corresponding to FIG. 2, FIG. 3, FIG. 4, and FIG. 5 may be implemented by the mobility management device provided in this embodiment.

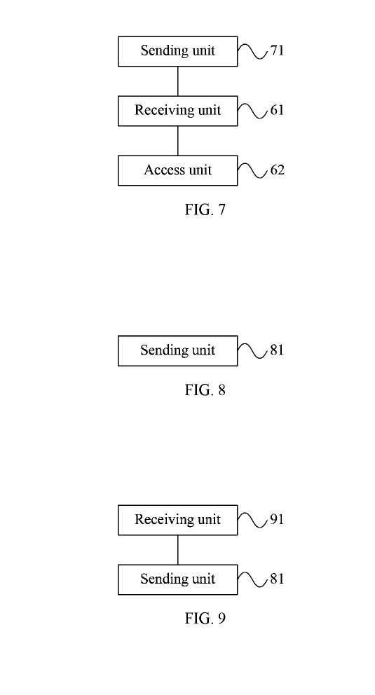

Optionally, as shown in FIG. 7, the mobility management device provided in this embodiment may further include a sending unit 71, which may be configured to send second indication information to the UE, where the second indication information is used for indicating that a mobile communications network, to which the mobility management device belongs, supports the UE to perform the equipment access processing.

The receiving unit 61 in this embodiment may further receive a second access request message sent by the UE; accordingly, the sending unit 71 is specifically configured to send a second access response message to the UE, where the second access response message includes the second indication information.

In an optional embodiment of the present invention, if the first access request message is an attach request message, the access unit 62 may specifically construct a context of the UE, where the context of the UE is generated by the mobility management device according to subscription data of the UE provided by an HLR/HSS, or generated by the mobility management device according to the first indication information and according to local configuration data or default data, and accepts the first access request message according to the first indication information.

In an application scenario of the embodiment of the present invention, the access unit 62 may further send a first create session request message to a gateway device according to the first indication information, where the first create session request message includes third indication information, and the third indication information is used for instructing the gateway device to perform a first charging policy for a data service of the UE, or instructing the gateway device to use the third indication information to obtain and perform a first charging policy for a data service of the UE.

In another application scenario of the embodiment of the present invention, the access unit 62 may further receive an activate PDP context request message sent by the UE, and send a second create session request message to the gateway device according to the first indication information, where the second create session request message includes fourth indication information, and the fourth indication information is used for instructing the gateway device to perform the first charging policy for the data service of the UE, or instructing the gateway device to use the fourth indication information to obtain and perform the first charging policy for the data service of the UE.

In an optional embodiment of the present invention, if the first access request message is a PDN connectivity request message or the activate PDP context request message, the access unit 62 may specifically send a third create session request message to the gateway device according to the first indication information, where the third create session request message includes fifth indication information, and the fifth indication information is used for instructing the gateway device to perform the first charging policy for the data service of the UE, or instructing the gateway device to use the fifth indication information to obtain and perform the first charging policy for the data service of the UE.

In an optional embodiment of the present invention, if the first access request message is a location update request message, the access unit 62 may specifically send a delete bearer request message to the gateway device according to the first indication information, receive a delete bearer response message sent by the gateway device, and send a fourth create session request message to the gateway device, where the fourth create session request message includes sixth indication information, and the sixth indication information is used for instructing the gateway device to perform the first charging policy for the data service of the UE, or instructing the gateway device to use the sixth indication information to obtain and perform the first charging policy for the data service of the UE.

In an optional embodiment of the present invention, if the first access request message is the location update request message, the access unit 62 may further specifically send a modify bearer request message to the gateway device according to the first indication information, where the modify bearer request message includes seventh indication information, and the seventh indication information is used for instructing the gateway device to perform the first charging policy for the data service of the UE, or instructing the gateway device to use the seventh indication information to obtain and perform the first charging policy for the data service of the UE.

Optionally, the receiving unit 61 may further receive a third access request message sent by the UE, where the third access request message includes eighth indication information, and the eighth indication information is used for indicating that the UE cancels the equipment access; accordingly, the access unit 62 may further cancel the equipment access for the UE according to the eighth indication information.

In an optional embodiment of the present invention, if the third access request message is the PDN connectivity request message or the activate PDP context request message, the access unit 62 may specifically send a sixth create session request message to the gateway device according to the eighth indication information, where the sixth create session request message includes tenth indication information, and the tenth indication information is used for instructing the gateway device to perform a second charging policy for the data service of the UE, or instructing the gateway device to use the tenth indication information to obtain and perform a second charging policy for the data service of the UE.

In an optional embodiment of the present invention, if the third access request message is the location update request message, if the context of the UE in the mobility management device is generated according to the local configuration data or the default data, or if the mobility management device cannot acquire the subscription data of the UE from the HLR/HSS, or if the subscription data of the UE acquired by the mobility management device from the HLR/HSS does not allow access of the UE, the access unit 62 may specifically perform a detach procedure according to the eighth indication information.

In an optional embodiment of the present invention, if the third access request message is the location update request message, the access unit 62 may specifically send the delete bearer request message to the gateway device according to the eighth indication information, receive the delete bearer response message sent by the gateway device, and send a sixth create session request message to the gateway device, where the sixth create session request message includes eleventh indication information, and the eleventh indication information is used for instructing the gateway device to perform the second charging policy for the data service of the UE, or instructing the gateway device to use the eleventh indication information to obtain and perform the second charging policy for the data service of the UE.

In an optional embodiment of the present invention, if the third access request message is the location update request message, the access unit 62 may further specifically send the modify bearer request message to the gateway device, where the modify bearer request message includes twelfth indication information, and the twelfth indication information is used for instructing the gateway device to perform the second charging policy for the data service of the UE, or instructing the gateway device to use the twelfth indication information to obtain and perform the second charging policy for the data service of the UE.

In this embodiment, a mobility management device receives, by using a receiving unit, a first access request message sent by a UE, where the first access request message includes first indication information, and the first indication information is used for indicating that the UE performs equipment access processing, so that an access unit can perform equipment access for the UE according to the first indication information. This avoid a problem in the prior art that a UE needs to establish a subscription relationship with an operator in order to access the Internet through a mobile communications network, thereby improving access flexibility of the UE.

FIG. 8 is a schematic structural diagram of a user equipment according to another embodiment of the present invention. As shown in FIG. 8, the user equipment in this embodiment may include a sending unit 81, configured to send a first access request message to a mobility management device, where the first access request message includes first indication information, and the first indication information is used for indicating that the UE performs equipment access processing, so that the mobility management device performs equipment access for the UE according to the first indication information.

All functions of the UE in the embodiments corresponding to the foregoing FIG. 2, FIG. 3, FIG. 4, and FIG. 5 may be implemented by the user equipment provided in this embodiment.

Optionally, as shown in FIG. 9, the user equipment provided in this embodiment may further include a receiving unit 91, configured to receive second indication information sent by the mobility management device or a wireless access device, where the second indication information is used for indicating that a mobile communications network, to which the mobility management device or the wireless access device belongs, supports the UE to perform the equipment access processing.

For example, the sending unit 81 in this embodiment may further send a second access request message to the mobility management device; accordingly, the receiving unit 91 may be specifically configured to receive a second access response message sent by the mobility management device, and the second access response message includes the second indication information.

Optionally, the sending unit 81 may further be configured to send a third access request message to the mobility management device, where the third access request message includes eighth indication information, and the eighth indication information is used for indicating that the UE cancels equipment access, so that the access unit is further configured to cancel the equipment access for the UE according to the eighth indication information.

In this embodiment, a user equipment sends a first access request message to a mobility management device by using a sending unit, the first access request message includes first indication information, and the first indication information is used for indicating that a UE performs equipment access processing, so that the mobility management device can perform equipment access for the UE according to the first indication information. This avoid a problem in the prior art that a UE needs to establish a subscription relationship with an operator in order to access the Internet through a mobile communications network, thereby improving access flexibility of the UE.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The foregoing integrated unit may be accomplished through hardware, or through hardware plus a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device or the like) to perform a part of the steps of the methods described in the embodiments of the present invention. The foregoing storage medium includes: any medium that can store program code, such as a USB flash drive, a removable hard disk, a read-only memory (Read-Only Memory, ROM for short), a random access memory (Random Access Memory, RAM for short), a magnetic disk, or an optical disc.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. An access method, comprising:
receiving, by a mobility management device, a first message sent by a user equipment (UE), wherein the first message comprises first indication information, and the first indication information is used for indicating that the UE performs equipment access, wherein the equipment access is a procedure in which the UE registers in a mobile communications network when there is no valid subscription data of the UE; and
sending, by the mobility management device, a second message to a gateway device according to the first indication information, wherein the second message comprises second indication information, and the second indication information is used for instructing the gateway device to perform a charging policy for a data service of the UE;
wherein the charging policy is that the gateway device sends a triggering message to a portal server to trigger to complete charging processing, and the portal server sends a webpage for data service charging to the UE according to the triggering message, wherein the webpage prompts a user of the UE to input a credit card account number to purchase a charging quota or to input information of an existing charging account in order to complete the charging processing.

2. The method according to claim 1, wherein before the receiving, by the mobility management device, the first message sent by the UE, the method further comprises:
sending, by the mobility management device, third indication information to the UE, wherein the third indication information is used for indicating that the mobile communications network, to which the mobility management device belongs, supports the UE to perform the equipment access.

3. The method according to claim 1, wherein the first message is an attach request message; and the method further comprises:
constructing, by the mobility management device, a context of the UE, wherein the context of the UE is generated by the mobility management device according to subscription data of the UE provided by a Home Location Register/Home Subscriber Server (HLR/HSS), or is generated according to the first indication information by the mobility management device according to local configuration data or default data; and
accepting, by the mobility management device, the attach request message according to the first indication information.

4. The method according to claim 3, wherein the second message is a create session request message, and the sending, by the mobility management device, the create session request message to the gateway device is performed before the accepting, by the mobility management device, the attach request message according to the first indication information.

5. The method according to claim 3, wherein after the accepting, by the mobility management device, the attach request message according to the first indication information, the method further comprises:
receiving, by the mobility management device, an activate packet data protocol (PDP) context request message sent by the UE;
wherein the second message is a create session request message, and the sending, by the mobility management device, the create session request message to the gateway device is performed after the receiving, by the mobility management device, the activate PDP context request message sent by the UE.

6. The method according to claim 1, wherein the first message is a packet data network (PDN) connectivity request message or an activate PDP context request message; and the second message is a create session request message.

7. The method according to claim 1, wherein the first message is a location update request message, and wherein before the sending, by the mobility management device, the second message to the gateway device, the method further comprises:
sending, by the mobility management device, a delete bearer request message to the gateway device according to the first indication information, and
receiving, by the mobility management device, a delete bearer response message sent by the gateway device.

8. The method according to claim 1, wherein the message is a location update request message; and the second message is a modify bearer request message.

9. A mobility management device, comprising:
a receiver, configured to receive a first message sent by a user equipment (UE), wherein the first message comprises first indication information, and the first indication information is used for indicating that the UE performs equipment access, wherein the equipment access is a procedure in which the UE registers in a mobile communications network when there is no valid subscription data of the UE; and
a sender, configured to send a second message to a gateway device according to the first indication information, wherein the second message comprises second indication information, and the second indication information is used for instructing the gateway device to perform a charging policy for a data service of the UE;
wherein the charging policy is that the gateway device sends a triggering message to a portal server to trigger to complete charging processing, and the portal server sends a webpage for data service charging to the UE according to the triggering message, wherein the webpage prompts a user of the UE to input a credit card account number to purchase a charging quota or to input information of an existing charging account in order to complete the charging processing.

10. The mobility management device according to claim 9, wherein the sender is further configured to send third indication information to the UE, wherein the third indication information is used for indicating that the mobile communications network, to which the mobility management device belongs, supports the UE to perform the equipment access.

11. The mobility management device according to claim 9, wherein the first message is an attach request message, the second message is a create session request message, and the mobility management device further comprises:
a processor, configured to construct a context of the UE, wherein the context of the UE is generated according to subscription data of the UE provided by a Home Location Register/Home Subscriber Server (HLR/HSS), or generated according to the first indication information and according to local configuration data or default data, and after the sender sends the create session request message accept the first message according to the first indication information.

12. The mobility management device according to claim 9, wherein the first message is an attach request message, the second message is a create session request message, and the mobility management device further comprises:
a processor, configured to construct a context of the UE, wherein the context of the UE is generated according to subscription data of the UE provided by a Home Location Register/Home Subscriber Server (HLR/HSS), or generated according to the first indication information and according to local configuration data or default data, and accept the first message according to the first indication information;
wherein the receiver is further configured to receive an activate packet data protocol (PDP) context request message sent by the UE after the processor accepts the attach request message;
wherein the sender configured to send the create session request message is configured to send the create session request message after the receiver receives the activate PDP context request message.

13. The mobility management device according to claim 9, wherein the first message is a packet data network (PDN) connectivity request message or an activate PDP context request message; and the second message is a create session request message.

14. The mobility management device according to claim 9, wherein the first message is a location update request message; and the second message is a create session request message;
wherein the sender is further configured to send a delete bearer request message to the gateway device according to the first indication information, and the receiver is further configured to receive a delete bearer response message sent by the gateway device.

15. The mobility management device according to claim 9, wherein the first message is a location update request message; and the second message is a modify bearer request message.

16. A user equipment (UE), comprising:
a sender device, configured to send a first access request message to a mobility management device, wherein the first access request message comprises first indication information, and the first indication information is used for indicating that the UE performs equipment access, so that the mobility management device performs the equipment access for the UE according to the first indication information;
wherein the equipment access is a procedure in which the UE registers in a mobile communications network when there is no valid subscription data of the UE.

17. The user equipment according to claim 16, further comprising:
a receiver device configured to receive second indication information sent by the mobility management device or a wireless access device, wherein the second indication information is used for indicating that the mobile communications network, to which the mobility management device or the wireless access device belongs, supports the UE to perform the equipment access.

18. The user equipment according to claim 17, wherein:
the sender is further configured to send a second message to the mobility management device;
wherein the receiving unit is configured to receive a response message sent by the mobility management device, wherein the response message comprises the second indication information.
